(19) United States
(12) Patent Application Publication
(10) Pub. No.: US 2010/0106643 A1
(43) Pub. Date: Apr. 29, 2010

(54) METHOD AND SYSTEM FOR PERFORMING A MONETARY TRANSACTION THROUGH A MOBILE COMMUNICATION DEVICE

(76) Inventor: Ajay Adiseshann, Maharashtra (IN)

Correspondence Address: LESTER H. BIRNBAUM, 6 OAKMOUNT COURT, SIMPSONVILLE, SC, 29681, US

(21) Appl. No.: 12/452,190

(22) PCT Filed: Jun. 22, 2007
(86) PCT No.: PCT/IN2007/000256

§ 371 Date: Dec. 18, 2009

(51) Int. Cl. G06Q 20/00

(52) U.S. Cl. 705/42

(57) ABSTRACT

The invention provides a method and a system for performing a monetary transaction through a mobile communication device. The monetary transaction is performed through a Paymate. The transaction details of the monetary transaction are initially communicated to the Paymate, which confirms the transaction details with a payer through the mobile communication device. The Paymate authenticates the payer for the monetary transaction and communicates a transaction request to the payer's account. The transaction request is verified and executed at the payer's account, to complete the monetary transaction.

### BACKGROUND

The present invention relates to the field of monetary transactions. More specifically, the present invention relates to performing monetary transactions by using mobile communication devices.

With the rapid development of trade and commerce across the world, most financial institutions already have or are in the process of becoming computerized. Computerization helps them to automate their internal businesses and is a substitute for their manual labor facilities for performing transactions. Traditional exercises, such as manual clearance of cheques and depositing of cash, are now being replaced by an automated, computer-based transaction system, which is a step toward cashless payment transactions.

The present technology drive for a cashless transaction system is geared toward the use of mobile communication devices to make monetary transactions. The use of these mobile communication devices to make monetary transactions expedites the entire process and also saves the time required for a person to go to a bank and do the paperwork. Further, from a buyer's and a seller's perspective, transactions are complete at the point-of-sale, making them safer and faster by using mobile communication devices.

Various methods have been proposed for performing a monetary transaction by using a mobile communication device. One of the methods uses embedded software. This embedded software provides a user interface, which can be used by a buyer to select different fields and enter the details required to make payment. Most of such software is provided in expensive mobile communication devices. Moreover, some embedded software requires an Internet connection to complete transactions. Furthermore, some embedded software may not be compatible with the different mobile communication service providers.

Another method for performing monetary transactions by using mobile communication devices provides a buyer with the option of making payment by using prepaid credit. This prepaid credit is the amount of money paid by buyers to service providers for their mobile communication devices. Consequently, buyers cannot make purchases that are worth more than the total amount of their prepaid credit. Further, they need to remember various details such as their credit account numbers, validation period, and so forth, required to make a payment.

In light of the facts stated above, there is a need for a method and a system, which enables buyers to perform monetary transactions by using various mobile communication devices. Further, there is a need for a method and a system, which does not restrict buyers from performing monetary transactions by using their mobile communication devices, based on their prepaid credit.

### SUMMARY

An object of the invention is to provide a method and system for performing a monetary transaction by using a mobile communication device.

Another object of the invention is to provide a method for performing the monetary transaction through various communication services available on the mobile communication device, for example, Short Messaging Service (SMS), Interactive Voice Response Service (IVRS), Wireless Transfer Protocols, and so forth.

Another object of the invention is to provide a method for performing the monetary transaction by using a mobile communication device that does not have embedded software.

Yet another object of the invention is to provide a method for performing the monetary transaction by using a mobile communication device, using various transaction options specified by a payer.

To achieve the objectives mentioned above, the invention provides a method and a system for performing a monetary transaction through a Paymate. The Paymate is a unique mobile payment platform and an ecosystem that has been conceived, developed and implemented by the applicant to enable a payer and a payee to transact with each other through a mobile communication device. The Paymate enables the mobile communication device to function as a virtual debit or credit card or bank account. The method includes communicating the transaction details of the monetary transaction to the Paymate, which communicates the transaction details to the payer through the mobile communication device, for confirmation. The payer communicates the confirmation for the monetary transaction through the mobile communication device. The confirmation includes a transaction identifier and a transaction amount as well as a Personal Identification number (PIN). The Paymate authenticates the payer for the monetary transaction. After authentication, the Paymate sends a transaction request to the payer's account, e.g., a bank account. The transaction request is verified and executed at the payer's account for the completion of the monetary transaction. Thereafter, a confirmatory message is sent to the payer and the payee, giving the status of the transaction.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a schematic representation of a monetary transaction, using a mobile communication device through a Paymate, in accordance with various embodiments of the invention;

FIG. 2 is a block diagram illustrating the functional modules of Paymate, in accordance with an embodiment of the invention;

FIG. 3 is a flowchart depicting a method for performing a monetary transaction, using a mobile communication device through Paymate, in accordance with an embodiment of the invention; and

FIG. 4 is a flowchart depicting a method for performing a monetary transaction, using a mobile communication device through Paymate, in accordance with another embodiment of the invention.

### DESCRIPTION OF THE PREFERRED EMBODIMENTS

Various embodiments of the invention provide a method and a system for performing a monetary transaction by using a mobile communication device. The method enables a payer to carry out the monetary transaction with a payee through a Paymate. The Paymate is a unique mobile payment platform and an ecosystem that has been conceived, developed and implemented to enable the payer and the payee to perform a monetary transaction by using a mobile communication device. The Paymate enables the mobile communication device to function like a virtual debit or credit card, and communicates a transaction request to a payer's account, for execution.

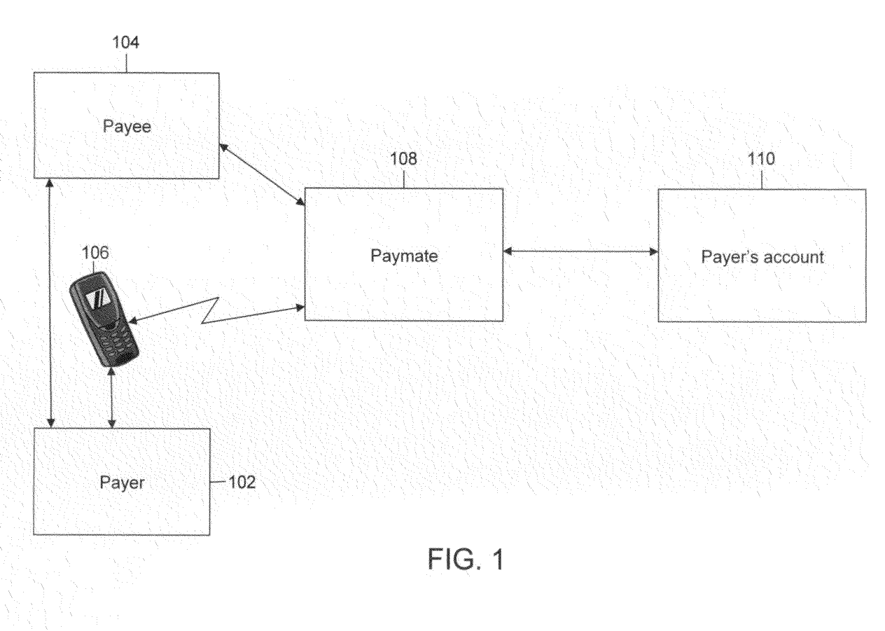

FIG. 1 is a schematic representation of a monetary transaction, using a mobile communication device 106 through a Paymate 108, in accordance with various embodiments of the invention. FIG. 1 includes a payer 102, a payee 104, a mobile communication device 106, a Paymate 108 and a payer's account 110.

The monetary transaction involves a transaction between payer 102 and payee 104 by mobile communication device 106. In various embodiments of the invention, the transaction details of the monetary transaction are communicated to Paymate 108 by payer 102 and/or payee 104. In various embodiments of the invention, payee 104 may be an online merchant, a retailer, a service provider, a telemarketing vendor, an ordinary person, and so forth.

Paymate 108 confirms the transaction details with payer 102 through mobile communication device 106. In various embodiments of the invention, mobile communication device 106 may be a mobile phone, a landline telephone, a Personal Digital Assistant (PDA), and so forth.

Paymate 108 processes the transaction details and communicates a transaction request to payer's account 110. Further, the transaction request is verified and executed at Payer's account 110. In various embodiments of the invention, payer's account 110 may be a debit account, a credit account, a voucher account, a savings account, a current account, a fixed deposit, a recurring account, and so forth. In an embodiment of the invention, payer's account 110 is associated with a bank.

In various embodiments of the invention, payer 102 is registered with Paymate 108 to carry out the monetary transaction. Paymate 108 registers payer 102 on the basis of the identification number of mobile communication device 106, and provides a Personal Identification Number (PIN) to payer 102 to carry out the monetary transaction. In an embodiment of the invention, payer's account 110 may provide the PIN to payer 102. In an embodiment of the invention, payee 104 may also be registered with Paymate 108.

In various embodiments of the invention, payer 102 initiates the monetary transaction with payee 104, and payee 104 communicates the transaction details to Paymate 108. In another embodiment of the invention, payer 102 communicates the transaction details to Paymate 108. Further, payer 102 provides the identification number of mobile communication device 106 to payee 104, to carry out the monetary transaction through mobile communication device 106.

In an embodiment of the invention, payer 102 may purchase an item from a merchant website and initiate the monetary transaction through Paymate 108 by choosing an option for payment against the purchase. In another embodiment of the invention, payer 102 initiates the monetary transaction by calling a merchant call center and asking a call center executive to perform the monetary transaction through Paymate 108. In another embodiment of the invention, payer 102 initiates the monetary transaction via Paymate 108 over a retail counter. In yet another embodiment of the invention, payer 102 initiates the monetary transaction by availing of a service from a service provider and making payment after the generation of a transaction bill.

In an embodiment of the invention, payer 102 may initiate a personal monetary transaction by sending the transaction details to Paymate 108 through mobile communication device 106.

In various embodiments of the invention, the transaction details communicated to Paymate 108 may include a transaction identifier and a transaction amount. The transaction details are communicated to Paymate 108 by payer 102 to confirm the monetary transaction. In various embodiments of the invention, the transaction identifier is a code generated with reference to the monetary transaction. In an embodiment of the invention, the transaction identifier is generated by payee 104. In another embodiment of the invention, the transaction identifier may be generated by Paymate 108. Further, in various embodiments of the invention, the transaction amount is an amount of money associated with the monetary transaction.

In various embodiments of the invention, Paymate 108 and payer 102 communicate with each other through mobile communication device 106. In an embodiment of the invention, Paymate 108 and payer 102 may communicate with each other by sending a text message by Short Message Service (SMS). In another embodiment of the invention, Paymate 108 and payer 102 may communicate with each other by an Interactive Voice Response Service (IVRS). Payer 102 may communicate with Paymate 108 by a short code. For example, Paymate 108 may have ‘1111’ as a short code, with every communication sent to ‘1111’ reaching Paymate 108. The short code is the same for all mobile communication service providers. In an embodiment of the invention, the short code is provided to payer 102 by Paymate 108 at the time of registration. In another embodiment of the invention, the short code is provided to payer 102 by payee 104 during the initiation of the monetary transaction.

In yet another embodiment of the invention, payer 102 may communicate through wireless transfer protocols. Payer 102 may require a software/application on mobile communication device 106 for this purpose. The software/application provides a Graphical User Interface (GUI) on mobile communication device 106, to communicate the transaction details to Paymate 108. The software/application enables payer 102 to connect with Paymate 108 over secured protocols such as Wireless Application Protocol (WAP), Binary Runtime Environment for Wireless (BREW), Hyper Text Transfer Protocol (HTTP), and so forth.

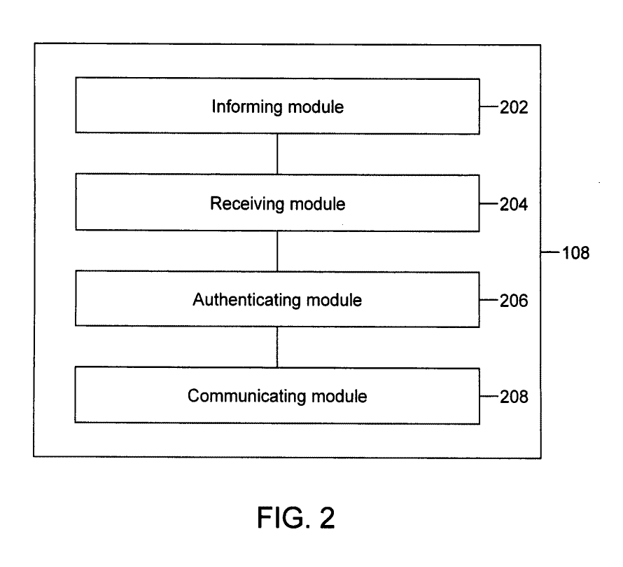

FIG. 2 is a block diagram illustrating the functional modules of Paymate 108, in accordance with an embodiment of the invention. Paymate 108 includes an informing module 202, a receiving module 204, an authenticating module 206 and a communicating module 208.

Paymate 108 enables the execution of the monetary transaction by processing the transaction details through various modules. Informing module 202 sends the transaction details to payer 102 on mobile communication device 106, for confirmation. Payer 102 communicates a confirmation of the monetary transaction, to confirming module 204, through mobile communication device 106. Confirming module 204 sends the confirmation to authenticating module 206 for the authentication of payer 102. On authentication, a transaction request is communicated to payer's account 110 by communicating module 208, to execute the monetary transaction.

Informing module 202 informs the transaction details to payer 102, for confirmation. In an embodiment of the invention, informing module 202 informs the transaction details to payer 102 by sending a text message on mobile communication device 106. In another embodiment of the invention, informing module 202 informs the transaction details to payer 102 through IVRS.

In various embodiments of the invention, the transaction details include the transaction identifier and the transaction amount. The transaction identifier is a code generated with reference to the monetary transaction. In an embodiment of the invention, the transaction identifier is an alpha code generated by Paymate 108 for the monetary transaction. The alpha code is a temporary code generated for a short duration of time with reference to the monetary transaction. The alpha code should be confirmed by payer 102 within the given duration of time, to execute the monetary transaction.

In another embodiment of the invention, payee 104 may generate a transaction identifier for the monetary transaction. This transaction identifier may be a unique code that is generated against a transaction bill for a service availed by payer 102. The transaction identifier is communicated to payer 102 and Paymate 108 by payee 104. In various embodiments of the invention, payee 104 may communicate the transaction identifier to payer 102 through SMS, IVRS, the Internet, on telephone, in person or with a transaction bill statement. In an embodiment of the invention, payee 104 may communicate the short code for Paymate 108 and other transaction details to payer 102.

Confirming module 204 receives confirmation for the monetary transaction from payer 102 through mobile communication device 106. In various embodiments of the invention, confirmation is received for the transaction details communicated by informing module 202. The confirmation may include the transaction identifier, the transaction amount and the PIN. Confirming module 204 sends the confirmation details to authenticating module 206, for authentication of payer 102.

Authenticating module 206 authenticates payer 102 to perform the monetary transaction. In an embodiment of the invention, authenticating module 206 compares the PIN and the identification number of the mobile communication device with the registration details of payer 102, for authentication.

Communicating module 208 communicates the transaction request to payer's account 110, to execute the monetary transaction. In various embodiments of the invention, the transaction request may be a debit request or a credit request. In an embodiment of the invention, the transaction amount is debited from payer's account 110 and transferred to payee 104. In another embodiment of the invention, the transaction amount is provided by payee 104 and is credited to payer's account 110.

In various embodiments of the invention, the modules of Paymate 108 may be implemented in the form of software, hardware, firmware, or combinations of thereof.

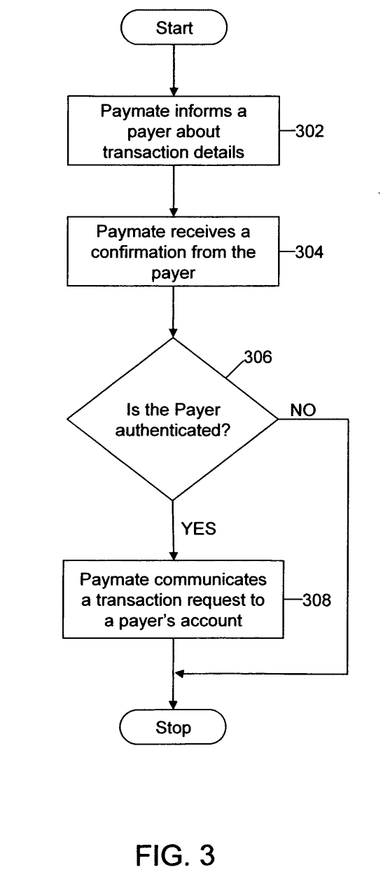

FIG. 3 is a flowchart depicting a method for performing a monetary transaction, using a mobile communication device through a Paymate, in accordance with an embodiment of the invention.

At 302, a Paymate, such as Paymate 108, communicates the transaction details of the monetary transaction to a payer such as payer 102, for confirmation. The transaction details may include the transaction identifier and the transaction amount.

In an embodiment of the invention, the Paymate communicates the transaction details to the payer by sending a text message through SMS on his mobile communication device such as mobile communication device 106. In another embodiment of the invention, the Paymate informs the payer on his/her mobile communication device by IVRS. In yet another embodiment of the invention, the Paymate communicates the transaction details to the payer through wireless transfer protocols on a mobile communication device.

In an embodiment of the invention, the Paymate may inform payers about the status of their account, e.g., the balance in their savings accounts.

At 304, the payer sends a confirmation for the monetary transaction to the Paymate, through the mobile communication device. In various embodiments of the invention, the payer may confirm the monetary transaction by sending the transaction identifier, the transaction amount and the PIN. In an embodiment of the invention, a keyword, for example, ‘pay’ may be sent by the payer in the text message, to make payment to the payee, such as payee 104. The identification number of the mobile communication device of the payee is also sent to the Paymate with the keyword, the transaction amount and the PIN. In an embodiment of the invention, the payer sends the alpha code in the text message to the Paymate. In another embodiment of the invention, the payer may provide the transaction amount and the PIN to the Paymate through IVRS.

At 306, is it checked whether the payer is authenticated to perform the monetary transaction. The Paymate authenticates the payer to perform the monetary transaction. In an embodiment of the invention, the payer is authenticated by comparing the information received from the payer at 304 with the registration details. The Paymate compares the identification number of the mobile communication device and the PIN received from the payer with the registration details of the payer, e.g., the identification number of the mobile communication device and the PIN, which are stored at the Paymate, to authenticate the payer.

In another embodiment of the invention, authentication is based on the information received from the payer at 304 and the payee. the Paymate compares the transaction details received from the payer with the transaction details provided by the payee, for authentication. In yet another embodiment of the invention, authentication is based on the validity of the alpha code.

If the payer is authenticated at 306, 308 is performed. However, if authentication fails, the monetary transaction is not executed.

At 308, the Paymate communicates the transaction request to the payer's account. The transaction request is verified and executed at the payer's account, to complete the monetary transaction.

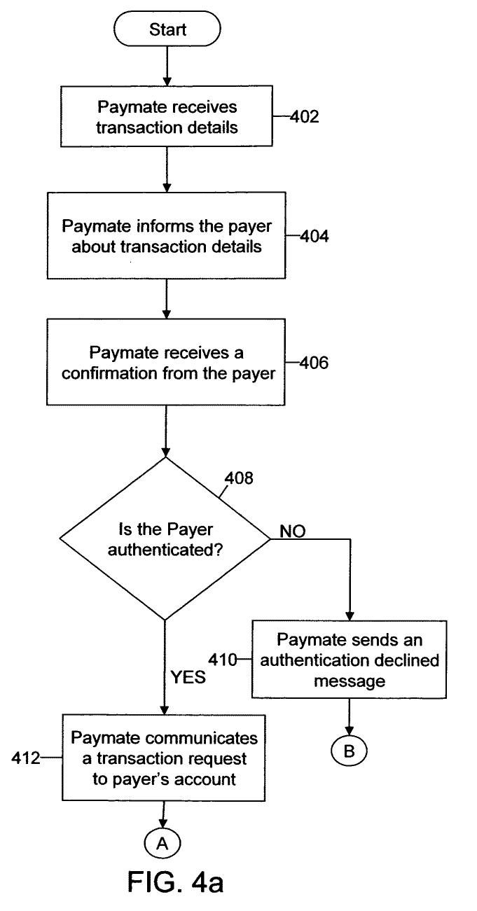

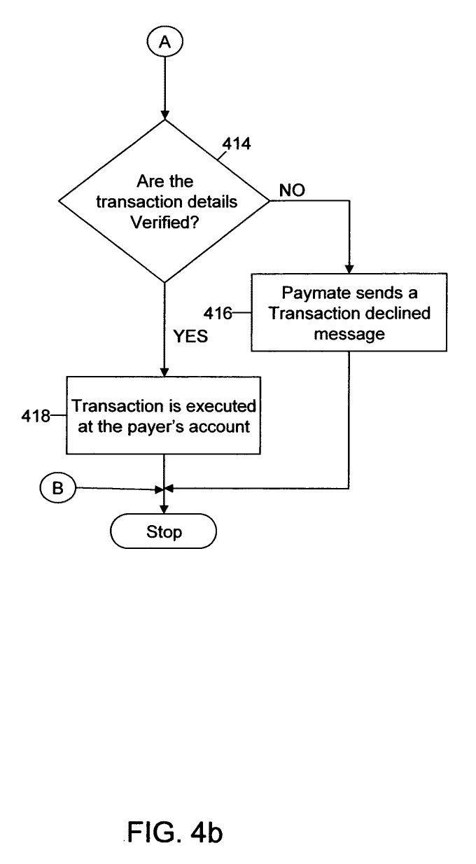

FIG. 4 is a flowchart depicting a method for performing a monetary transaction, using the mobile communication device through the Paymate, in accordance with another embodiment of the invention.

At 402, the Paymate receives the transaction details of the monetary transaction. In various embodiments of the invention, the monetary transaction is initiated by the payer with the payee. For example, the payer may initiate the monetary transaction on a merchant website, a merchant call center, a transaction counter, with a service provider, and so forth. Subsequently, the transaction details are communicated to the Paymate, to execute the monetary transaction.

In various embodiments of the invention, the transaction details are communicated to the Paymate by SMS, IVRS, wireless transfer protocol, the Internet, and so forth. In an embodiment of the invention, the transaction details are communicated by the payer. In another embodiment of the invention, the transaction details are communicated by the payee.

At 404, the Paymate communicates the transaction details of the monetary transaction to the payer on the mobile communication device. This has been explained in detail in conjunction with FIG. 3 at 302.

At 406, the Paymate receives confirmation pertaining to the monetary transaction from the payer. This has been explained in detail in conjunction with FIG. 3 at 304.

At 408, is it checked whether the payer is authenticated to perform the monetary transaction. This has been explained in detail in conjunction with FIG. 3 at 306. If the payer is not authenticated at 408, 410 is performed. However, if the payer is authenticated at 408, 412 is performed.

At 410, the Paymate communicates a transaction status message to the payer. This transaction status message is an authentication-failed message. The authentication-failed message is sent to the payer to inform him that the authentication procedure has failed and the monetary transaction cannot be executed. Thereafter, the process is terminated.

At 412, the Paymate communicates the transaction request to the payer's account, to execute the monetary transaction. The transaction request includes the transaction details required for execution of the monetary transaction. In various embodiments of the invention, the transaction request may be a debit request or a credit request. In an embodiment of the invention, the Paymate communicates the transaction request to the voucher account. In various embodiments of the invention, the voucher account may be a gift voucher, a cash voucher, a payment voucher, and so forth.

At 414, it is checked whether the transaction details have been verified at the payer's account. The verification process may involve details such as the money balance in the payer's account, the transaction rights of the payer, the validity duration of the payer's account, and so forth. If the transaction details have been verified, 416 is performed. However, if the transaction details have not been verified, 418 is performed.

At 416, the monetary transaction is executed at the payer's account. In an embodiment of the invention, the transaction amount is debited from the payer's account and transferred to the payee. In another embodiment of the invention, the transaction amount is provided by the payee and is credited to the payer's account.

Thereafter, the Paymate communicates a transaction status message to the payer. The transaction status message is a transaction-complete message. In an embodiment of the invention, the transaction-complete message may include the status of the payer's account after the monetary transaction has been completed.

In various embodiments of the invention, the Paymate communicates the transaction-complete message to the payer through the mobile communication device. In an embodiment of the present invention, the Paymate communicates the transaction-complete message to the payee.

At 418, the Paymate communicates a transaction-status message to the payer. The transaction-status message is a transaction-declined message. In an embodiment of the invention, the transaction-declined message may include the verification details, which resulted in the failure of the monetary transaction. In various embodiments of the invention, the Paymate communicates the transaction-declined message to the payer through the mobile communication device. In an embodiment of the present invention, the Paymate communicates the transaction-declined message to the payee.

Various embodiments of the invention provide a number of advantages. In accordance with various embodiments of the invention, a payer can make a cashless transaction from his debit or credit account by using his mobile communication device. The payer does not have to reveal his debit account or credit card details to the payee, which makes the transaction fast and secure. Further, the payer does not require a mobile communication device with embedded software to make a monetary transaction. The monetary transaction can be performed through various services available with mobile communication devices, such as SMS, IVRS, and so forth. Further, the monetary transaction can be initiated through various modes such as a telephone, the Internet, in person, through transaction counters, SMS, email, and so forth.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for performing a monetary transaction through a mobile communication device, the method comprising:
a. informing a payer about the monetary transaction, the payer being informed on the mobile communication device, the payer being informed by a Paymate, wherein the information comprises transaction details, the transaction details comprising at least one of a transaction identifier and a transaction amount;
b. receiving a confirmation for the monetary transaction from the payer, the confirmation being communicated by the payer to the Paymate through the mobile communication device, the confirmation comprising a Personal Identification Number (PIN) of the payer and at least one of the transaction identifier and the transaction amount;
c. authenticating the payer on the Paymate for the monetary transaction, the authentication of the payer being based on at least one of an identification number of the mobile communication device, the PIN of the payer, the transaction identifier and the transaction amount, and
d. communicating a transaction request to a payer's account, the transaction request being communicated by the Paymate to transact the transaction amount from the payer's account.

2. The method of claim 1, wherein the Paymate receives the transaction details from a payee.

3. The method of claim 1, wherein the payer initiates the monetary transaction by accessing the Paymate through a communication interface.

4. The method of claim 3, wherein the communication interface is at least one of a merchant website, a merchant call center, an Interactive Voice Response Service (IVRS) linked to the Paymate, a Short Message Service (SMS) linked to the mobile communication device and a wireless transfer protocol available to the mobile communication device.

5. The method of claim 1, wherein the Paymate and the payer communicate by at least one of a text message, wireless transfer protocol and an Interactive Voice Response Service (IVRS) linked to the Paymate.

6. The method of claim 1, wherein authenticating the payer on the Paymate comprises communicating a transaction-declined message by the Paymate to at least one of the payer and a payee, the transaction-declined message being communicated if the authentication fails.

7. The method of claim 1, wherein the payer's account is at least one of a debit account, a credit account and a voucher account.

8. The method of claim 7, wherein the transaction request to the payer's account comprises a debit request for debiting the transaction amount from at least one of the debit account, the credit account and the voucher account.

9. The method of claim 7, wherein the transaction request to the payer's account comprises a credit request for crediting the transaction amount to at least one of the debit account, the credit account and the voucher account.

10. The method of claim 1, wherein the PIN is linked to the payer's account.

11. The method of claim 1, wherein the PIN is provided to the payer by the Paymate.

12. The method of claim 1, wherein the transaction identifier is a temporary code generated for the monetary transaction.

13. The method of claim 1 further comprising communicating a confirmatory message by the Paymate to at least one of the payer and the payee, the confirmatory message being communicated after the transaction is complete on the payer's account, the confirmatory message comprising transaction status details.

14. A Paymate for performing a monetary transaction through a mobile communication device, the Paymate comprising:
a. an informing module, the informing module for informing a payer about the monetary transaction, the payer being informed on the mobile communication device, wherein the information comprises transaction details, the transaction details comprising at least one of a transaction identifier and a transaction amount;
b. a receiving module, the receiving module for receiving a confirmation for the monetary transaction from the payer, the confirmation being communicated by the payer to the Paymate through the mobile communication device, the confirmation comprising a Personal Identification Number (PIN) of the payer and at least one of the transaction identifier and the transaction amount;
c. an authenticating module, the authenticating module for authenticating the payer on the Paymate for the monetary transaction, the authentication of the payer being based on at least one of an identification number of the mobile communication device, the PIN of the payer, the transaction identifier and the transaction amount, and
d. a communicating module, the communicating module for communicating a transaction request to a payer's account, the transaction request to transact the transaction amount from the payer's account.

15. The Paymate according to claim 14, wherein the payer is registered with the Paymate by the identification number of the mobile communication device and the PIN.

16. The Paymate according to claim 14, wherein the payee is registered with the Paymate.

17. The Paymate according to claim 14, wherein the payer's account is at least one of a debit account, a credit account and a voucher account.

18. The Paymate according to claim 14, wherein the Paymate is accessible to the payer, the payee and the payer's account through a communication interface.

19. The Paymate according to claim 17, wherein the communication interface is at least one of a merchant website, a merchant call center, an Interactive Voice Response Service (IVRS) linked to the Paymate, a Short Message Service (SMS) linked to the mobile communication device, and a wireless transfer protocol available to the mobile communication device.

20. A computer program product for performing a monetary transaction through a mobile communication device, the computer program product comprising: a computer readable medium comprising:
a. a program instruction means for informing a payer about the monetary transaction, the payer being informed on the mobile communication device, the transaction details being informed by a Paymate, wherein the information comprises transaction details, the transaction details comprising at least one of a transaction identifier and a transaction amount;
b. a program instruction means for receiving a confirmation for the monetary transaction from the payer, the confirmation being communicated by the payer to the Paymate through the mobile communication device, the confirmation comprising a Personal Identification Number (PIN) of the payer and at least one of the transaction identifier and the transaction amount;
c. a program instruction means for authenticating the payer on the Paymate for the monetary transaction, the authentication of the payer being based on at least one of an identification number of the mobile communication device, the PIN of the payer, the transaction identifier and the transaction amount, and
d. a program instruction means for communicating a transaction request to a payer's account, the transaction request being communicated by the Paymate to transact the transaction amount from the payer's account.

21. The computer program product of claim 20, wherein the payer initiates the monetary transaction by accessing the Paymate through a communication interface.

22. The computer program product of claim 20, wherein the transaction identifier is a temporary code generated for the monetary transaction.

23. The computer program product of claim 20, further comprising communicating a confirmatory message by the Paymate to at least one of the payer and the payee, the confirmatory message being communicated after the transaction is complete on the payer's account, the confirmatory message comprising transaction status details.
